(19) United States
(12) Patent Application Publication
(10) Pub. No.: US 2007/0097595 A1
(43) Pub. Date: May 3, 2007

(54) Multipurpose programmable adjustable keyboard (MPAK)

(75) Inventors: Zoran Radivojevic, Helsinki (FI); Kenichi Hashizume, Gunma-ken (JP)

Correspondence Address: HARRINGTON & SMITH, PC, 4 RESEARCH DRIVE, SHELTON, CT, 06484-6212, US

(73) Assignee: Nokia Corporation

(21) Appl. No.: 11/223,873

(22) Filed: Sep. 8, 2005

(51) Int. Cl. H01G 4/35

(52) U.S. Cl. 361/302

(57) ABSTRACT

A keyboard device formed of a generally planar interaction module having first and second sides, comprising a plurality of input indicia displayed on a first side, a matrix of micro-switchers coupled to the second side of the interaction module formed of a generally planar first electrode sheet having a first plurality of generally parallel conductive traces each separated by one of a first plurality of insulation traces on a first side of the first generally planar electrode sheet, and a generally planar second electrode sheet having a second plurality of generally parallel conductive traces each separated by one of a second plurality of insulation traces on a first side of the second generally planar electrode sheet, and a generally planar piezo sheet having a first side coupled to the first side of the generally planar first electrode sheet and a second side coupled to the first side of the generally planar second electrode sheet.

### TECHNICAL FIELD

This invention relates generally to a configurable device for the entry of data into a computing device.

### BACKGROUND

The human-computing platform (CP) interface has presented a challenge to system designers for decades. Despite the proliferation of myriad computing platforms that require human interaction and data entry, the most common interface element, the mouse, has evolved very little since its invention over thirty years ago. To a considerable extent, the success of the mouse is the result of the numerous options and possible ways in which a mouse can be configured as well as the ease by which a user can operate a mouse.

Despite the proven utility of the mouse as a means for human interaction with a computer, there exists a need for keyboards through which can be entered textual data and the like. Different application platforms require different keyboard sizes, key positions and performances. Furthermore, the optimal configuration of a keyboard varies from user to user as different users have different interface requirements. For example, the preferred spacing of keys may differ between senior citizens and children. In addition, the required keys may differ from a scientist to a data entry specialist. With reference to FIG. 1, there is illustrated multiple configurations of keyboards 11 known in the art each satisfying different requirements such as the size, shape, number, and placement of keys or input indicia 10.

Ideally, a successful input device provides a user with a number configuration options and the possibility to adjust the input device to the operation of specific applications. The therefore exists a need for a dynamically configurable user interface.

### SUMMARY OF THE PREFERRED EMBODIMENTS

In accordance with an exemplary embodiment of the invention a keyboard device is formed of a generally planar interaction module (IM) having a first and second side comprising a plurality of input indicia displayed on a first side, a matrix of micro-switchers (MMS) coupled to the second side of the interaction module formed of a generally planar first electrode sheet having a first plurality of generally parallel conductive traces each separated by one of a first plurality of insulation traces on a first side of the first generally planar electrode sheet, and a generally planar second electrode sheet having a second plurality of generally parallel conductive traces each separated by one of a second plurality of insulation traces on a first side of the second generally planar electrode sheet, and a generally planar piezo sheet having a first side coupled to the first side of the generally planar first electrode sheet and a second side coupled to the first side of the generally planar second electrode sheet.

In a further exemplary embodiment of the invention, a mobile device is formed of a configurable keyboard formed of a generally planar IM having a first and second side having a plurality of input indicia displayed on a first side, a MMS comprising a first and second generally planar electrode sheets the first electrode sheet coupled to the second side of the generally planar IM, and a piezo sheet interposed between the first and second electrode sheets, a memory in which is stored configuration data for the IM, the MMS, and the piezo sheet, and a processor coupled to the memory, the IM, the MMS, and the piezo sheet.

In a further exemplary embodiment of the invention, a method involves providing an IM on which is displayed a plurality of input indicia, detecting a force applied to the IM and a position at which the force is applied, determining at least one of the plurality of input indicia corresponding to the position at which the force is applied, and providing tactile feedback in response to the determination of the application of force.

In a further exemplary embodiment of the invention, a program of machine-readable instructions, tangibly embodied on an information bearing medium and executable by a digital data processor is provided, to perform actions directed toward interacting with a display, the actions formed of dynamically configuring a display comprising a plurality of input indicia, detecting a force applied to the display and a position at which the force is applied, determining at least one of the plurality of input indicia corresponding to the position at which the force is applied and providing tactile feedback in response to the determination of the application of force.

### BRIEF DESCRIPTION OF THE DRAWINGS

The foregoing and other aspects of these teachings are made more evident in the following Detailed Description, when read in conjunction with the attached Drawing Figures, wherein:

FIG. 1 is an illustration of various keyboards known in the art.

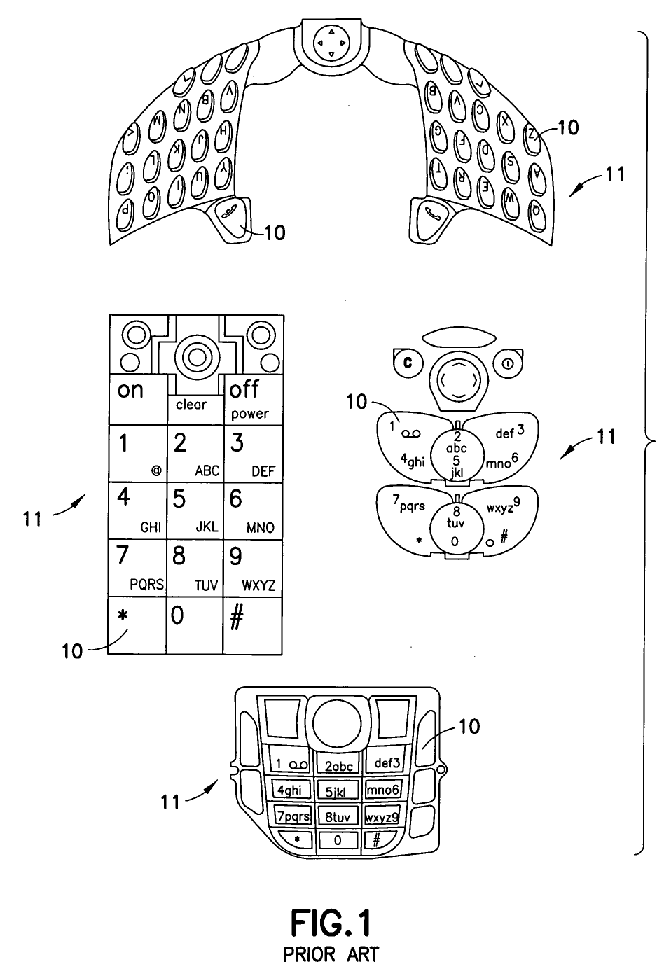

FIG. 2 is a logic flow chart of an exemplary embodiment of a method of the invention.

FIG. 3 is a cross section diagram of an exemplary embodiment of a Multipurpose Programmable Adjustable Keyboard (MPAK) of the invention.

FIG. 4 includes FIGS. 4A and 4B and is a top view (FIG. 4A) and side view (FIG. 4B) of an exemplary embodiment of an electrode sheet of the invention.

FIG. 5. is a diagram of an exemplary embodiment of the resistances associated with an electrode sheet of the invention.

FIG. 6 is a diagram of an exemplary embodiment of a piezo sheet according to the invention.

FIG. 7 is a diagram of an exemplary embodiment of a device for practicing the invention.

### DETAILED DESCRIPTION

In an exemplary embodiment of the present invention, there is provided a multipurpose adjustable/programmable keyboard (MPAK) providing a user configurable interface for interacting with computing platforms. In an exemplary embodiment of the invention, an MPAK is formed of a Matrix of Micro-Switchers (MMS) coupled to an Interaction Module (IM). The IM functions as a user configurable surface upon which is displayed indicia of data entry elements, such as numbers, letters, icons, logos, or the like. The MMS is coupled to the IM in such a manner so as to both detect physical contact between a user and the IM, as well as to identify the area, or point, of contact between the user and the MMS. In one exemplary embodiment of the invention described more fully below, a piezo sheet, incorporating a number of piezo electric elements, is utilized to both detect pressure applied to the MMS as the result of interaction between the user and the MMS as well as to provide tactile feedback to the user to acknowledge that an interaction has been detected.

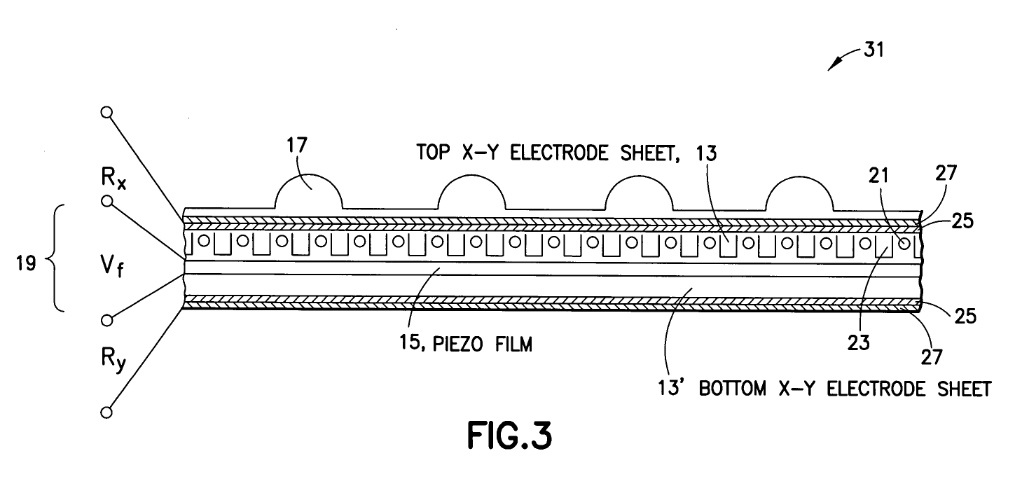

With reference to FIG. 3, there is illustrated an exemplary embodiment of an MPAk 31 according to the invention. As noted above, the MPAk 31 is formed, generally, of an IM 17 coupled to, or in close proximity to, an MMS 19. As illustrated, IM 17 forms a generally planar display layer. MMS 19 is formed of three predominantly planar layers situated one atop the other to form a sandwich of the layers. While preferably fabricated of generally planar components, in operation both the IM 17 and the MMS 19 may be bent or otherwise deformed to be coupled to a non-planar surface. As described more fully below, the layers forming the MMS 19 may include a first and second X-Y electrode sheet 13, 13′ wherein a piezo sheet 15 is interposed between the X-Y electrode sheets 13, 13′.

In an exemplary embodiment, IM 17 is formed of a printed material, such as a flexible mat, wherein the size, position, and shape of the buttons may be configured to conform to the requirements of a user. Flexible mats are inexpensive to fabricate and can be provided to consumers in numerous variations for use with devices, particularly mobile devices, such as a mobile telephone. Furthermore, such flexible mats can be removed and, if desired, replaced. In addition to providing numerous variations of flexible mats, a user may specify desired customizations to a flexible mat for use with a device wherein the customized flexible mat is fabricated and provided to the user. Such customizations may be specified, for example, by a user over the internet for use by the manufacturer in producing a customized product.

In an alternative exemplary embodiment, the IM 17 may be formed, in part, of a flexible, bistable display 20, such as an electrochromic or electrophoretic display. Suitable displays for a programmable key mat embodiment are bistable, flexible, thin and light displays. Bi-stability means that the power consumption is zero for still images. Bi-stability is achieved by physical processes integrated into the display technology. At the present those are displays based on physical phenomena such: electrophoresis, electrochromic, cholesteric and nanomaterials involved. Bi-stability can be realized by the following approaches: bistable SuperTwist Nematic-Liquid Crystal Display (STN-LCD), cholesteric LCD, electrophoretic, and MEMS based displays and Electrochromic displays. The structure of the bistable STN-LCD is basically similar to conventional STN-LCD. The bi-stability is achieved using a special LC mixture and the surface treatment of the LC cell. The operation of the cholesteric LCD is based on two stable states of the LC material and the selective light reflection. The cholesteric LCD does not have polarizers and color filters.

The operation of the electrophoretic displays is based on the light interaction with pigment particles of which position can be controlled by electric voltage.

A common, though not required, feature for all of these displays is low power consumption (<1 mW/cm²) where energy is required only for a change of the image/pattern (still image). Furthermore, an image is set within a second. This provides a very power efficient approach where very lithe energy is spent for patterning the still image, which is stays for a long time without an external power supply. Also, an automatic refreshment of the key-mat (e.g., once/day) is foreseen and can be provided for different application concepts ranging form phone to larger applications (e.g., like touch screen panels of A4 size). A second exemplary feature is flexibility of the displays. Flexibility is typically obtained by using polymeric substrates, which provide that the display is bent when a force (provided by, e.g., a finger, a stylus) is applied on the display's surface.

As described above, such displays exhibit the characteristic of low power consumption and require energy only to change a pattern displayed upon them. Such displays provide the ability to dynamically change the pattern visible upon the IM 17. For example, as described more fully below, the pattern can be altered to provide large buttons, small buttons, Arabic character buttons, Chinese character buttons, or other user defined patterns and input indicia 10.

With continued reference to FIG. 3, there is illustrated an exemplary embodiment of the first and second X-Y electrode sheet 13, 13′. The two X-Y electrode sheets 13, 13′ form a cross-bar position sensing matrix. In an exemplary embodiment of the invention, each X-Y electrode sheet 13, 13′ is constructed similarly and differs one from the other in their orientation. Specifically, each X-Y electrode sheet 13, 13′ is rotated approximately 90 degrees from the other. Preferably, as is described more fully below, conductive traces 21 on each X-Y electrode sheet 13, 13′ are positioned to face each other, separated by the piezo sheet 15.

There is further illustrated a measured resistance of first X-Y electrode sheet 13, Rₓ, a measured resistance of second X-Y electrode sheet 13′, R_{y}, and a measured voltage of the piezo sheet 15, V_{F}. When pressure is applied to the IM 17, the MMS 19 operates to determine the X-Y coordinates of the point or area at which the pressure is applied. Such a determination is made possible through the use of the cross-layered interconnections formed between the two perpendicularly placed X-Y electrode sheets 13, 13′.

As described more fully below, resistances Rₓ and R_{y} can be measured and processed to ascertain or otherwise determine the X-Y coordinates at which pressure is applied. The force of an applied pressure (F) can be determined from an examination of the voltage V_{f} which arises from a deformation of the piezo sheet 15, such as that which occurs when a pressure is applied to the piezo sheet 15. The piezo sheet 15 is preferably formed of numerous piezo electric elements. When a piezo electric element 61 is physically deformed, a voltage is produced. Conversely, applying a voltage to a piezo electric element 61 results in the physical deformation of the piezo electric element. In an exemplary embodiment of the invention described more fully below, this physical attribute of piezo electric elements is utilized to provide tactile feedback to a user. The level of force with which a user deforms the piezo sheet may be translated into differentiated inputs by their corresponding voltage differences in the piezo sheet 15. Such level of force detection is particularly advantageous in gaming implementations. In gaming implementations, the level of detected force can be utilized to control gaming action such as, for example, the intensity with which an object is thrown in the game environment. In this manner, an MPAk 31 incorporated into an electronic gaming device serves to convert user inputs into electrical control inputs. In another exemplary embodiment, the MPAK 31 can be disposed along a surface of a robotic device to facilitate an interface between the robotic device and external stimuli.

Specifically, after processing the measured resistances and voltages, namely Rₓ, R_{y} and V_{F}, an electric pulse, or voltage, may be delivered to the piezo sheet 15 to provide tactile feedback to a user. If such a pulse is generated a short duration after pressure is applied by the user to the piezo sheet 15, the resulting deformation of the MPAK 31, specifically the deformation of one or more piezo electric elements 61, provides tactile feedback indicative of successful activation of the MPAK 31. BY “activation” is meant that a user input is determined to have taken place.

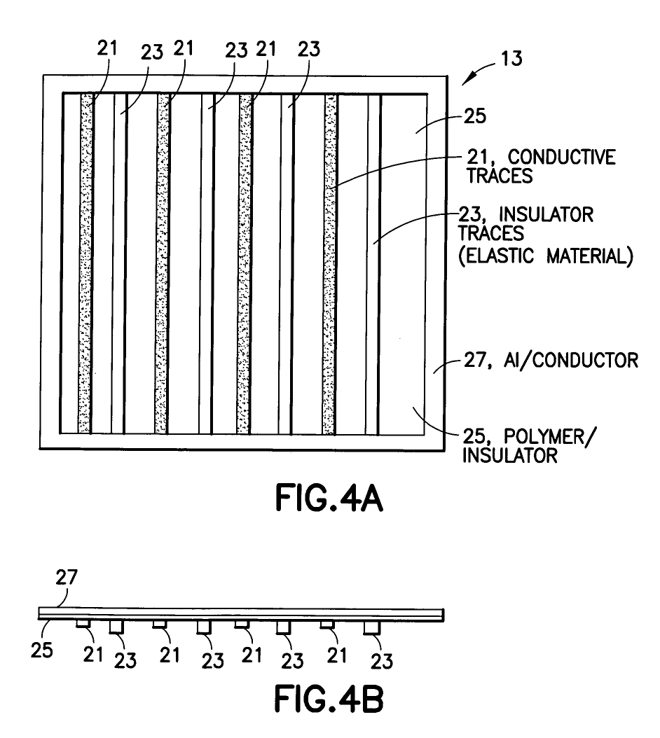

With reference to FIG. 4, there is illustrated both a top and a side view of an exemplary embodiment of an X-Y electrode sheet of the invention. Each X-Y electrode sheet 13, 13′ is formed of multiple parallel lines formed of alternating conductive traces 21 and insulating traces 23 patterned sequentially on a flexible substrate 25. In an exemplary embodiment of the invention, conductive traces 21 are formed of a conductive metal, insulating traces 23 are formed of an elastic polymer, and the flexible substrate 25 is formed of an insulator such as a polymide. Mated to a side of the generally planar flexible substrate 25 opposite the conductive and insulating traces 21, 23, there is positioned a generally planar conductor sheet 27 formed, for example, of aluminium or other conductive material. Note that the insulating traces 23 are slightly thicker than the conductive traces 21 and, hence, extend away from the flexible substrate 25 a greater distance than do the conductive traces 21. As such, the insulating traces 23 serve as stand-off lines, or traces, preventing unwanted contact between the conductive traces 21 and other conducting materials in the absence of a user applied pressure.

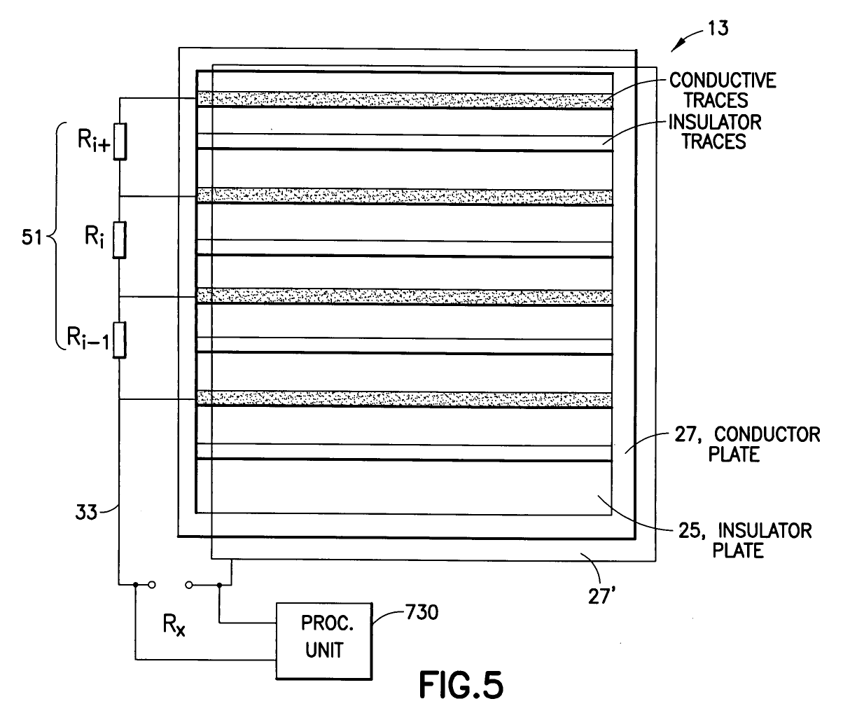

With reference to FIG. 5, there is illustrated a diagram of an X-Y electrode sheet 13 as well as the outline of an additional conductor sheet 27′ forming a part of X-Y electrode sheet 13′ (not shown). Determining the location of a particular conductive trace 21 when pressure is exerted upon it, for example, as the result of a user pressing upon it, may be accomplished as follows using an array 51 of resistors (Rᵢ) and a comparator circuit (not shown)or a processing unit described below. As illustrated, each conductive trace 21 forms a line indexed by i To each conductive trace 21 there is attributed a finite range of resistances. As a result, the number (i) of an activated line can be recognized by using a comparator circuit or processing unit. For example, when the X-Y electrode sheet 13 is pressed by a finger above the line i, the corresponding measured resistance Rx should be in a range between

$${\sum }_{i} ( {R}_{i - 1} ) and {\sum }_{i} ( {R}_{i + 1} ) .$$

In this manner, comparing the measured resistance Rₓ to the known resistances corresponding to an activation of each conductive trace 21, it is possible to determine which conductive trace 21, indexed by i, was activated.

In the exemplary illustrated configuration of the resistor array, only one readout line 33 is required to access all the conductive traces 21. The array of addressing resistances, Rᵢ, can be formed of separate modules or may fabricated into the X-Y electrode sheet 13. The comparator circuitry, or processing unit 730, therefore functions to measure the resistance Rₓ, and to derive position information by matching Rₓ with a conductive trace or traces 21. As described, the exemplary algorithm is valid for determining a one dimensional position of pressure applied to a single X-Y electrode sheet 13. However, as described above, the inclusion of an additional X-Y electrode sheet 13′ oriented 90 degrees to the first, allows for determining a position in two orthogonal directions so as to ascertain, or otherwise determine, an X and Y coordinate of an applied pressure.

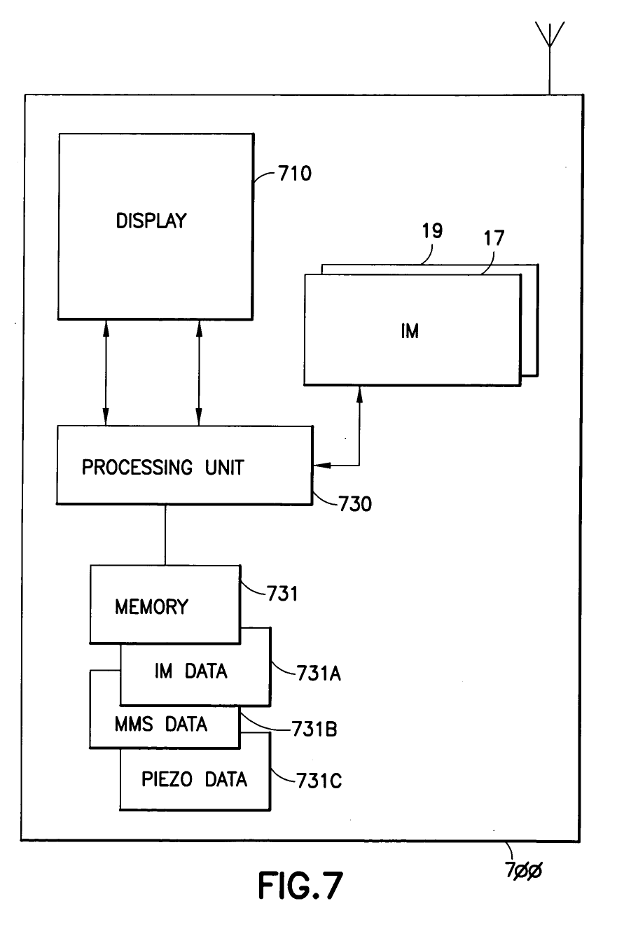

With reference to FIG. 7, there is illustrated a diagram of an exemplary embodiment of a device 700, preferably a mobile device, for practicing the invention. Device 700 is formed of a processing unit 730, such as a computer microprocessor. Processing unit 730 can be any unit capable of receiving digital or analog data, performing a manipulation of such data, and outputting a response. Processing unit 730 is coupled to a display 710 such that processing unit 730 controls the formation of an image upon display 710. Processing unit 730 can function to both configure the appearance of IM 17 as well as to determine an area of activation of IM 17.

A memory 731 is coupled to processing unit 730. The memory 731 is formed of stored IM data 731A and stored MMS data 731B. IM data 731A defines the placement of input indicia upon a surface of IM 17. IM data 731A can be formed of image data formed, for example, of button and key imagery corresponding to a desired placement of buttons and keys upon IM 17. As noted above, when the IM 17 is formed of an electrochromic or an electrophoretic display, the processing unit 17 can retrieve IM data 731A and output a signal to IM 17 to dynamically configure the layout of keys, buttons, and other input indicia 10. In such an instance, there is stored in MMS data 731B data that maps each interface indicia displayed on IM 17 to the X-Y coordinates corresponding to each input indicia 10. In addition, there is stored in MMS data 731B the relevant resistances, Rₓ and R_{y} required to determine the X-Y coordinates at which a force is applied to IM 17.

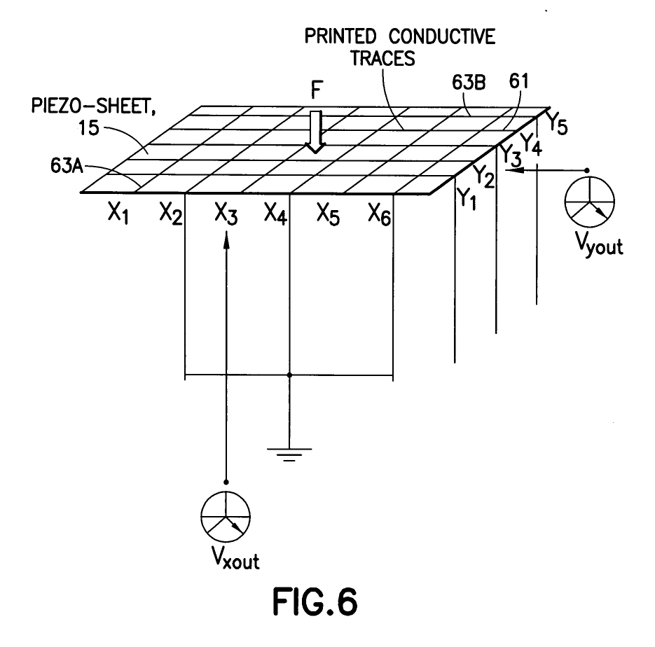

With reference to FIG. 6, there is illustrated an exemplary embodiment of a piezo sheet 15 according to the invention. Numerous conductive traces 63 are printed upon the piezo sheet 15. Preferably, the conductive traces 63 are arranged in two generally perpendicular sets. As illustrated, one set is formed of a series of conductive traces 63A arranged in the y-direction, Yᵢ, and a series of conductive traces 63B arranged in the x-direction, Xᵢ. As noted above, with reference to FIG. 3, a voltage V_{f} is measured for ascertaining if a pressure has been exerted upon IM 17 and for determining where such pressure was exerted. In addition to utilizing the MMS 19 for determining the site at which pressure is applied to IM 17, piezo sheet 15 may likewise be utilized to determine a point or area at which pressure is applied to the IM 17. Typically, the resolution arising from reliance of the piezo sheet 15 when determining a point of applied pressure is less than that afforded by the utilization of the MMS described above. However, in instances when such desired resolution is low, as when the indicia displayed upon IM 17 are relatively large, reliance on the piezo sheet 15 to determine the position at which force is applied in the absence of an MMS 19 can be more cost effective.

When a force F is applied to the piezo sheet 15, two voltages V_{yout} and Vₓₒᵤₜ are generated. These voltages can be interpreted by the processor unit 730 to determine the x-coordinate, Xᵢ, and the y-coordinate, Yᵢ of the point at which force F is applied. As shown, each pair of coordinates is associated with a piezo electric element 61. Similar to that which is described above with regards to MMS data 731B, there can be stored in piezo data 731C information mapping received voltages, V_{yout} and Vₓₒᵤₜ, to the x and y-coordinates of displayed IM 17 input indicia 10.

In an exemplary embodiment, after determining the position at which force F is applied to the IM 17, the processor unit 730 can transmit a voltage signal along an Xᵢ conductive trace 63A and a Yᵢ conductive trace 63B corresponding to at least one piezo electric element 61 in proximity to the point at which force F was determined to have been applied. By sending such a voltage signal, the corresponding piezo electric element or elements 61 are deformed. This deformation creates a tactile feedback informing the user that the provision of force upon an indicia of IM 17 was received, interpreted, and acknowledged.

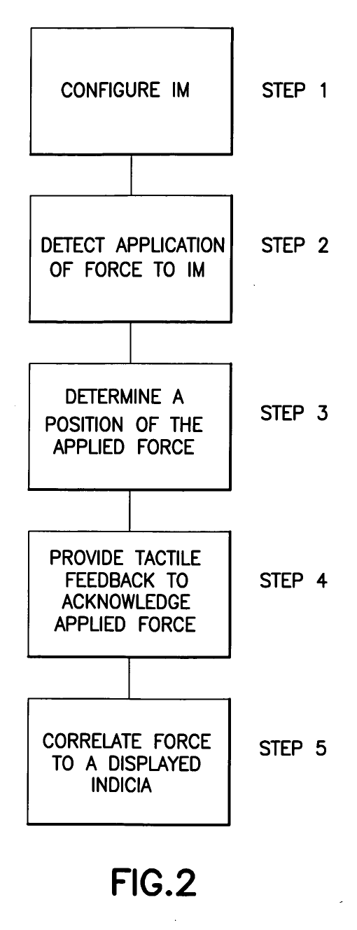

With reference to FIG. 2, there is illustrated an exemplary embodiment of the method of the invention. At step 1, the IM 17 is configured, preferably dynamically. As noted above, IM 17 can be formed of an electrochromic or an electrophoretic display. Such displays can be altered to display a desired image upon the reception of an input signal defining the desired display. Preferably, the processing unit 730 retrieves IM data 731A from the memory 731 and transmits the IM data 731A to IM 17 whereupon IM 17 is dynamically configured to present a display corresponding to IM data 731A. In the event that IM 17 is formed of a static or non-configurable material, such as a flexible mat, the IM 17 may not be dynamically configured.

At step 2, the application of a force F is detected as described above. In the instance that the MMS 19 is formed of orthogonally oriented electrode sheets 13, 13′, the measured resistances from electrode sheets 13, 13′ are received as inputs to processing unit 730. In the absence, of such electrode sheets 13, 13′, the voltages generated in the x and y directions by piezo sheet 15 serve as inputs to processing unit 730.

At step 3, either or both of the inputted resistances from the electrode sheets 13, 13′ and the inputted voltages from the piezo sheet 15 are utilized as inputs by processing unit 730 to determine the x and y coordinates at which the force F was applied to the IM 17.

At step 4, the processing unit 730 can send an output voltage signal to a piezo electric element or elements 61 in piezo sheet 15 at a position corresponding to the position at which the force F was determined to have been applied to IM 17. By so activating a piezo electric element or elements 15, a tactile response is generated to indicate the successful determination of the selection of an input indicia.

Lastly, at step 5 the data stored in MMS data 731B and piezo data 731C is retrieved by the processing unit 730 and utilized to correlate the location at which force was applied to the IM 17 to an input indicia 10 displayed at the position at which the force F was determined to have been applied.

Suitable materials for a piezo sheet are PVDF (Poly Vynilidene Fluoride) and P(VDF-TrFE) (PVDF-trifluoro ethylene copolymer). Typical dimension are in range of 0.1-0.5 mm thickness and an area of 50 mm×60 mm. These dimensions are suitable for phone applications. However, applications might be also larger and smaller. For instance, a touch-screen panel (size of about A4) could be targeted or smaller sheets could be MP3 player size.

Other exemplary suitable physical properties are the following: Electrical resistance: >10A12; Dielectric constant: 6.2 (for P(VDF-TrFE))and 6.0(for PVDF); and Anti-electric field: 40 MV/m (P(VDF-TrFE)), 45 MV/m (PVDF).

It is understood that the various exemplary embodiments described herein may be implemented in hardware or special purpose circuits, software, logic or any combination thereof. For example, some aspects may be implemented in hardware, while other aspects may be implemented in firmware or software which may be executed by a controller, microprocessor, processor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in hardware, software, firmware, special purpose circuits or logic, general purpose hardware or controller or other computing device, or some combination thereof.

Alternative exemplary embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys™, Inc. of Mountain View, Calif. and Cadence™ Design, of San Jose, Calif. automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Although described in the context of particular embodiments, it will be apparent to those skilled in the art that a number of modifications and various changes to these teachings may occur. Thus, while the invention has been particularly shown and described with respect to one or more exemplary embodiments thereof, it will be understood by those skilled in the art that certain modifications or changes may be made therein without departing from the scope and spirit of the invention as set forth above, or from the scope of the ensuing claims.

What is claimed is:

1. An input device comprising:
a generally planar interaction module (IM) having a first and second side, said first side for displaying a plurality of input indicia; and
a matrix of micro-switchers (MMS) coupled to said second side of said interaction module comprising:
a first electrode sheet comprising a first plurality of generally parallel conductive traces;
a second electrode sheet comprising a second plurality of generally parallel conductive traces, and
a piezo sheet having a first side coupled to said first side of said first electrode sheet and a second side coupled to said first side of said second electrode sheet.

2. The input device of claim 1 wherein said first and second electrode sheets are formed of the same material.

3. The input device of claim 1 wherein said IM comprises a flexible mat.

4. The input device of claim 3 wherein said flexible mat is removable.

5. The input device of claim 1 wherein said IM comprises an electrochromic display.

6. The input device of claim 1 wherein said IM comprises an electrophoretic display.

7. The input device of claim 1 wherein said first and second plurality of generally parallel conductive traces are oriented orthogonally one to the other.

8. The input device of claim 1 wherein said piezo sheet comprises a plurality of individually addressable piezo electric elements arrayed in a grid pattern.

9. The input device of claim 1 wherein said input indicia are dynamically configurable.

10. The input device of claim 1 wherein said input indicia are disposed in an electronic gaming device for converting user inputs to electrical control inputs.

11. The input device of claim 1 wherein said input indicia are disposed on a surface of a portable robotic device for interfacing said robotic device with external stimuli.

12. A mobile device comprising:
a configurable input surface comprising:
an IM comprising a first and second side, said first side for displaying a plurality of input indicia displayed on a first side;
a MMS comprising first and second electrode sheets, said first electrode sheet coupled to said second side of said generally planar IM; and
a piezo sheet interposed between said first and second electrode sheets;
a memory in which is stored configuration data for said IM, said MMS, and said piezo sheet; and
a processor coupled to said memory, said IM, said MMS, and said piezo sheet.

13. The mobile device of claim 12 wherein said MMS configuration data comprises a location of said plurality of input indicia.

14. The mobile device of claim 12 wherein said IM is dynamically configurable.

15. The mobile device of claim 12 wherein said IM comprises an electrochromic display.

16. The mobile device of claim 12 wherein said IM comprises an electrophoretic display.

17. The mobile device of claim 12 wherein said IM comprises a flexible mat.

18. The mobile device of claim 12 wherein said mobile device comprises a mobile telephone.

19. A method comprising:
providing an IM on which is displayed a plurality of input indicia;
detecting a force applied to said IM and a position at which said force is applied;
determining at least one of said plurality of input indicia corresponding to said position at which said force is applied; and
providing tactile feedback in response to said determination of said application of force.

20. The method of claim 19 comprising dynamically configuring said display of said input indicia.

21. The method of claim 20 wherein said configuring comprises retrieving data defining a placement of said plurality if indicia from a memory and outputting a signal to said IM to produce a display upon a surface of said IM.

22. The method of claim 20 comprising processing said retrieved data to produce said outputted signal.

23. The method of claim 19 wherein said providing said tactile response comprises applying a voltage to at least one piezo electric element located at a position corresponding to said position at which said force is applied.

24. A device comprising:
means for displaying a plurality of input indicia;
means for detecting a force applied to said means for displaying and a position at which said force is applied;
means for determining at least one of said input indicia corresponding to said position at which said force is applied; and
means for providing a tactile feedback in response to said detection of said applied force.

25. The device of claim 24 wherein said means for providing said tactile response comprises a piezo sheet.

26. The device of claim 24 wherein said means for detecting comprises a first and second electrode sheet.

27. The device of claim 24 wherein said means for displaying comprises a flexible mat.

28. The device of claim 24 wherein said means for displaying comprises a dynamically configurable display.

29. The device of claim 28 wherein said dynamically configurable display comprises an electrochromic display.

30. The device of claim 28 wherein said dynamically configurable display comprises an electrophoretic display.

31. A program of machine-readable instructions, tangibly embodied on an information bearing medium and executable by a digital data processor, to perform actions directed toward interacting with a display, the actions comprising:
dynamically configuring a display comprising a plurality of input indicia;
detecting a force applied to said display and a position at which said force is applied; and
providing tactile feedback in response to said determination of said application of force.

32. The program of claim 31 further comprising determining at least one of said plurality of input indicia corresponding to said position at which said force is applied.
